(19) United States
(12) Patent Application Publication
(10) Pub. No.: US 2025/0129987 A1
(43) Pub. Date: Apr. 24, 2025

(54) METHOD FOR OPERATING A PLANT FOR PRODUCING CEMENT CLINKER

(71) Applicant: KHD HUMBOLDT WEDAG GMBH, KÖLN (DE)

(72) Inventors: Niko HACENBERG, OVERATH (DE); André SYBON, KÖLN (DE)

(21) Appl. No.: 18/835,219

(22) PCT Filed: Feb. 2, 2023
(86) PCT No.: PCT/EP2023/052540

§ 371 Date: Aug. 1, 2024

(30) Foreign Application Priority Data
Feb. 3, 2022 (DE) 102022102561.6

(51) Int. Cl. F27B 7/36; C04B 7/48; F27D 19/00

(52) U.S. Cl. CPC F27B 7/36; C04B 7/48; F27D 2019/0068

(57) ABSTRACT

A method for operating a plant for producing cement clinker, wherein the plant comprises as plant units, in the direction of gas flow, at least one clinker cooler, at least one rotary kiln, at least one calciner, at least one heat-exchanger line including heat-exchanger cyclones, and at least one device for crushing raw meal and/or cement clinker, and also a corresponding plant for producing cement clinker. At least one plant unit is enclosed, whereby the plant unit is provided with a second covering with respect to the atmosphere, and the enclosure is subjected to process gas from a compressor.

### CROSS-REFERENCES TO RELATED APPLICATIONS

This application is a national phase of International Patent Application No. PCT/EP2023/052540, filed on Feb. 2, 2023, which claims the benefit of German Patent Application No. 10 2022 102 561.6, filed on Feb. 3, 2022, the entire disclosures of which are incorporated herein by way of reference.

### FIELD OF THE INVENTION

The invention relates to a method for operating a plant for producing cement clinker, wherein the plant, in the gas flow direction, has at least one clinker cooler, at least one rotary kiln, at least one calcinator, at least one heat exchanger line, consisting of cyclone heat exchangers, and at least one apparatus for comminuting raw meal and/or cement clinker in the form of plant assembles, and to a corresponding plant for producing cement clinker.

### BACKGROUND OF THE INVENTION

An oxy-fuel method is used to operate modern plants for producing cement clinker. In this method, a majority or all of the nitrogen-containing carrier air is replaced with carbon dioxide (CO₂), which comes from the combustion intended for the heat treatment of the raw meal used as raw material for the production. The meaning and purpose of this other way of carrying out the method is to obtain a low-nitrogen to nitrogen-free offgas that mostly consists of carbon dioxide (CO₂). This offgas, which is rich in carbon dioxide (CO₂), can then be injected underground. The absence of nitrogen here saves on unnecessary compression work. A pleasant side effect of the other gas composition is the inevitably associated lack of ejection of nitrous gases, since there is no longer any nitrogen to form nitrous gases. In this other way of carrying out the method, in the case of older and retrofitted plants the problem arises that infiltrated atmospheric air is sucked into the plant at some locations of the plant as a result of high gas flow velocities. Depending on where it enters the plant, this infiltrated atmospheric air can then lead to nitrous gases forming. The infiltrated air that has entered also increases the compression work required later for the injection operation. In retrofitted plants, which no longer have measures for avoiding nitrous gases on account of the other way of carrying out the method, the inflow of infiltrated air is especially undesirable, since nitrous oxide could then form unchecked.

The subsequently published application DE 10 2021 119 755 A1 discloses an enclosure for plant seals in order to prevent the inflow of infiltrated air through these seals.

It is an object of the invention to avoid the inflow of infiltrated air at all conceivable locations of the plant.

### SUMMARY OF THE INVENTION

The object according to the invention may be achieved by a method for operating a plant for producing cement clinker, having the features according to one or more embodiments disclosed herein. A corresponding plant for producing cement clinker is also disclosed in various embodiments.

According to the idea of the invention, provision is thus made to enclose at least one plant assembly, as a result of which the plant assembly has a second shell with respect to the atmosphere, and wherein process gas is applied to the enclosure in the form of a shell via a compressor. In principle, two ways of supplying the process gas are possible. In a first way of supplying the process gas, it is provided that the process gas is removed from the plant directly upstream of inflow into the plant assembly. This is possible at such locations where the temperature of the process gas is not too high, so that the removed process gas can be compressed by a compressor without the compressor suffering damage as a result of the high gas temperature or needing to be exchanged prematurely. In another way of supplying the process gas, provision may be made to remove the process gas from the plant at a suitable, central location. Suitable locations are where the process gas has already cooled down somewhat, that is to say in the cyclone heat exchangers, which are somewhat downstream as viewed in the gas flow direction. Low-dust locations in the plant can also serve as process gas source. In that case, this process gas does not have to be filtered to a great extent. Depending on the plant assembly, the shell can increase the size only to a very little extent and have a structure like a shell within a shell. However, it is also possible to accommodate the plant assembly like in a small hall or in a small container, so that the hall or the container are intended to enclose the shell. In order to stabilize the excess pressure, provision may be made to regulate the compressor. The pressure can also be kept constant by regulating an outlet valve.

Plant assemblies to be enclosed that come into consideration are classifiers, separators, vertical mills, impact hammer mills, clinker crushers at the outlet of a clinker cooler, tubular mills, bucket conveyors, conveyor belts, classifier combinations composed of a rod cage classifier and a V-shaped cascade classifier, cyclone heat exchangers and compressors. Firing plants on the accessible side can also be enclosed with process gas. In this respect, it is possible to operate the plant process gas pressure at between 10 mbar through 50 mbar and at up to 70 mbar below atmospheric pressure. By contrast, the enclosure is operated at a pressure of 1 mbar through 2 mbar up to 5 mbar below atmospheric pressure by compressing the process gas, which is kept at negative pressure with respect to the atmosphere. The negative pressure mode of operation ensures that no process gas can enter the atmosphere. However, the consequence of negative pressure operation is that infiltrated atmospheric air can be sucked in. The enclosures ensure that inadvertently sucked-in infiltrated air comes from the process gas itself. As an alternative, it is possible to operate the plant with process gas excess pressure. Locations where infiltrated air can be sucked in are locations where, on account of high flow velocities of the process gas, a Bernoulli negative pressure is produced, which can lead to infiltrated air being drawn in despite the nevertheless low plant excess pressure. The enclosure ensures that the then inadvertently drawn-in infiltrated air consists of the process gas itself.

### BRIEF DESCRIPTION OF THE DRAWINGS

The invention will be explained in more detail on the basis of the following figures, in which:

FIG. 1 shows a view of a ball mill of a plant for producing cement clinker from the PRIOR ART,

FIG. 2 shows the ball mill from FIG. 1, which is provided with an enclosure,

FIG. 3 shows a basic diagram of a plant assembly of a plant for producing cement clinker, which, according to a first configuration, is provided with a central process gas supply,

FIG. 4 shows a basic diagram of a plant assembly of a plant for producing cement clinker, which, according to a second configuration, is provided with a nearby process gas supply,

FIG. 5 shows a basic diagram of a plant assembly of a plant for producing cement clinker, which, according to a third configuration, is provided with a nearby process gas supply,

FIG. 6 shows a cyclone heat exchanger of a plant for producing cement clinker from the PRIOR ART,

FIG. 7 shows a cyclone heat exchanger of a plant for producing cement clinker, which is provided with an enclosure, and,

FIG. 8 shows a plant for producing cement clinker having partially enclosed plant assemblies.

### DETAILED DESCRIPTION OF THE PREFERRED EMBODIMENTS

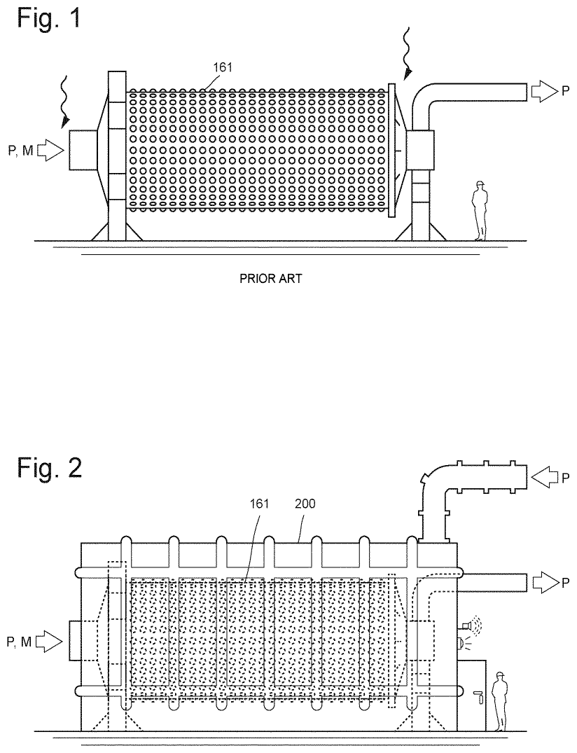

FIG. 1 shows a view of a ball mill 161 of a plant 100 for producing cement clinker from the PRIOR ART. The ball mill depicted here stands freely or under a roof for protection against weathering. For operation purposes, grinding material M is applied to the ball mill 161 pneumatically from the left, the grinding material being suspended in process gas P. Within the ball mill, the grinding material is comminuted and leaves the ball mill 161 in the form of dust with the exiting process gas P on the right-hand side, the dust of the grinding material M being suspended in the process gas. Although ball mills are operated by pneumatic charging at slight excess pressure with respect to the free atmosphere, it is possible, as a result of high flow velocities in the feed pipes, for a Bernoulli negative pressure to form, which draws in atmospheric air L and thus the process gas mixes with infiltrated air. The process gas P mixes with atmospheric air L at the locations where the ball mill 161 merges with static pipelines for the process gas P. These locations are marked with a wavy arrow. To illustrate the size of such a ball mill 161, a human is shown to somewhat the same scale on the right next to the ball mill.

FIG. 2 depicts the ball mill 161 from FIG. 1, which is provided with a shell 200 as enclosure. The ball mill 161 is completely enclosed by the shell 200, the process gas P with the grinding material M suspended therein being guided through the shell 200 on the left-hand side. It is also the case that the outflow of the process gas P is guided through the shell 200 on the right-hand side. In this configuration, it is provided that another process gas P is introduced into the shell 200 from a central location 220 of the plant 100 for producing cement clinker via a seepage line, shown here at the top right, and there maintains an excess pressure with respect to the gas pressure in the ball mill 161. It is not intended for the process gas P to flow out of the shell 200. Rather, leakages form, by way of which the process gas P, which is introduced at excess pressure, flows out of the shell. The idea of the invention is then that process gas P is then sucked in at the locations where infiltrated air is drawn into the ball mill 161, for example as a result of the formation of a Bernoulli negative pressure. This means that the process gas P in the ball mill 161 is not fouled by infiltrated air. This diagram also depicts a human, who stands in front of an open inspection door, on the right next to the enclosed ball mill. In the open state, a signalling lamp arranged thereabove and a signalling horn signal the open and therefore dangerous state of the inspection door, through which process gas P can be guided to locations where fresh breathable air is necessary for personnel located there.

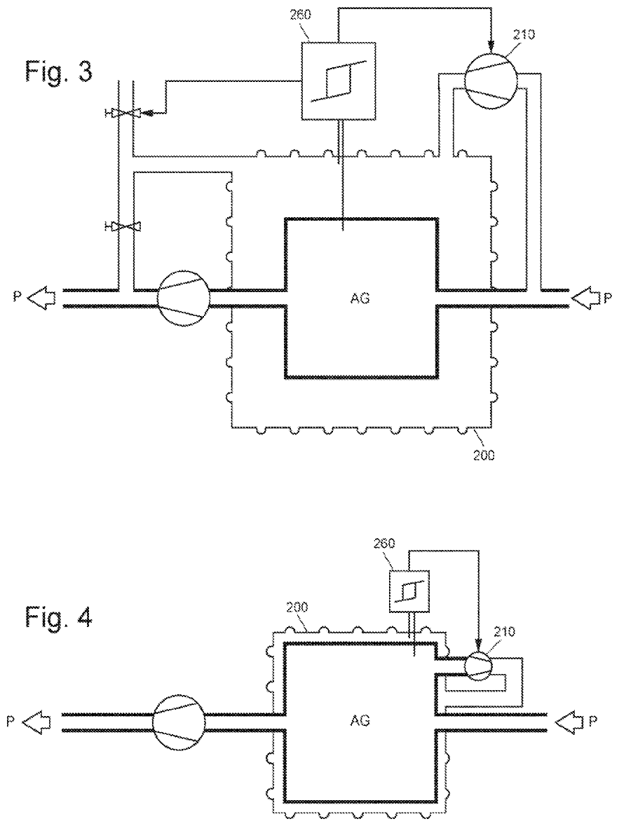

FIG. 3 outlines a basic diagram of a plant assembly AG of a plant 100 for producing cement clinker, which, according to a first configuration, is provided with a central process gas supply. This first configuration provides that process gas P is guided up from a central location, is compressed by a local compressor 210 and is conducted into the shell 200 surrounding the plant assembly AG. In order to keep the excess pressure in the shell constant, according to this configuration there is provision for a controller 260 to control the compressor. In this respect, the controller 260 increases the compressor power when the excess pressure in the shell 200 drops with respect to the pressure of the process gas P in the plant assembly AG, and vice versa. Specifically when there is a central supply of process gas P, a local compression of the process gas P directly upstream of the shell 200 is advantageous in order to avoid control fluctuations in the underlying gas supply network. As an alternative or in addition, it may be provided that the same, or a second, controller 260 controls an outlet valve 250, the opening width of which is set by the controller 260 such that, when the excess pressure rises, the opening width is increased, and vice versa.

FIG. 4 depicts another basic diagram of a plant assembly AG of a plant 100 for producing cement clinker, which, according to a second configuration, is provided with a nearby process gas supply. The configuration shown here provides that the shell increases the size as little as possible and surrounds the original plant assembly very closely. The beads, indicated by bulges, of the shell 200 and spacers, not expressly depicted here, keep the shell stable. Process gas P is drawn from the plant assembly AG itself, compressed by a local compressor 210 and conducted into the dedicated shell 200 of the plant assembly AG. To keep the excess pressure of the process gas P in the shell 200 constant, a controller 260 can regulate the compressor power of the compressor 210 such that, when the excess pressure in the shell 200 rises, the compressor power is lowered, and vice versa.

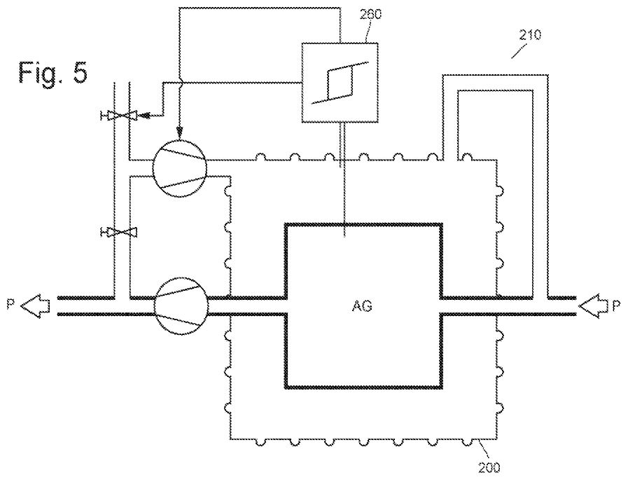

FIG. 5 depicts yet another basic diagram of a plant assembly AG of a plant 100 for producing cement clinker, which, according to a third configuration, is provided with a nearby process gas supply. The configuration shown here provides that the shell increases the size as little as possible and surrounds the original plant assembly very closely. The beads, indicated by bulges, of the shell 200 and spacers, not expressly depicted here, keep the shell stable. Process gas P is drawn from the process gas downstream of the plant assembly AG in the gas flow direction, compressed by a local compressor 210 and conducted into the dedicated shell 200 of the plant assembly AG. To keep the excess pressure of the process gas P in the shell 200 constant, a controller 260 can regulate the compressor power of the compressor 210 such that, when the excess pressure in the shell 200 rises, the compressor power is lowered, and vice versa. The configuration shown here provides that the process gas removed downstream in the gas flow direction continues to be fed to the gas inflow side of the plant assembly, in this configuration the process gas in the enclosure having the process gas pressure that is set upstream in the gas flow direction.

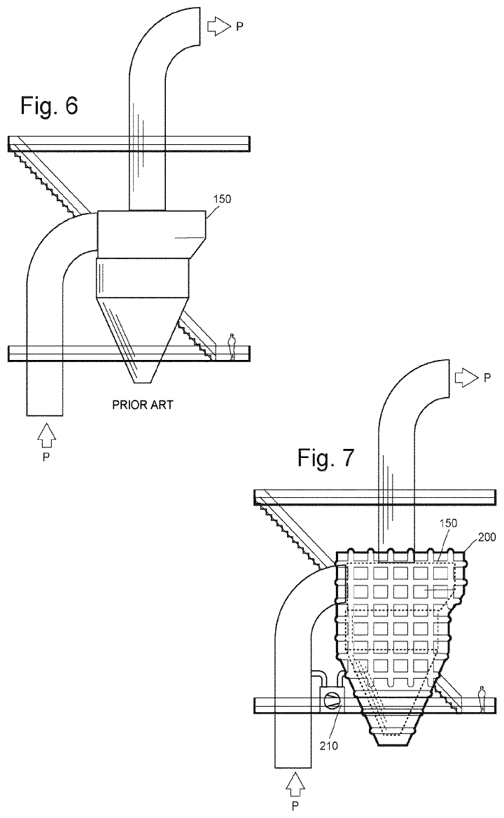

FIG. 6 shows a cyclone heat exchanger 150 of a plant 100 for producing cement clinker from the PRIOR ART. Cyclone heat exchangers of a plant 100 for producing cement clinker can themselves reach a height of up to 10 m. To depict the relative sizes, a human is shown on the right next to the cyclone heat exchanger 150 on a plane of a heat exchanger line. In cyclone heat exchangers, high flow velocities are deliberately generated in order to intensify the mixing of the raw meal with the process gas coming in the opposite direction. The high flow velocities also mean that infiltrated air is sucked into the cyclone heat exchangers 150 here at unsealed locations as a result of a Bernoulli negative pressure. Leakages cannot be completely prevented in the case of a plant 100, which “works” through fluctuations in the process gas pressure and expands and contracts again as a result of changing temperatures. Together with the high temperature prevailing there, corrosion or excess stress can cause locations to form small openings which, as a result of the inflow of infiltrated air, can quickly become so large that the inflow of infiltrated air is no longer negligible.

FIG. 7 shows, by comparison with FIG. 5, a cyclone heat exchanger 150 of a plant 100 for producing cement clinker, which is provided with a shell 200 in the form of an enclosure. The entire cyclone heat exchanger 150 is arranged in the shell 200 and process gas P is supplied to the shell 200 by a local compressor 210, which is at the level of the cyclone heat exchanger 150. If, then, undesired leakages in the cyclone heat exchanger 150 should arise, only the process gas Pis sucked in as infiltrated air, the process gas having been removed from the cyclone heat exchanger 150 directly upstream of the inflow of process gas P into the cyclone heat exchanger 150. Here, too, it is possible to provide a controller, as has been explained for the abstract embodiments relating to FIGS. 3 and 4. The controller may be a controller for the compressor power and/or the controller for an outlet valve 250.

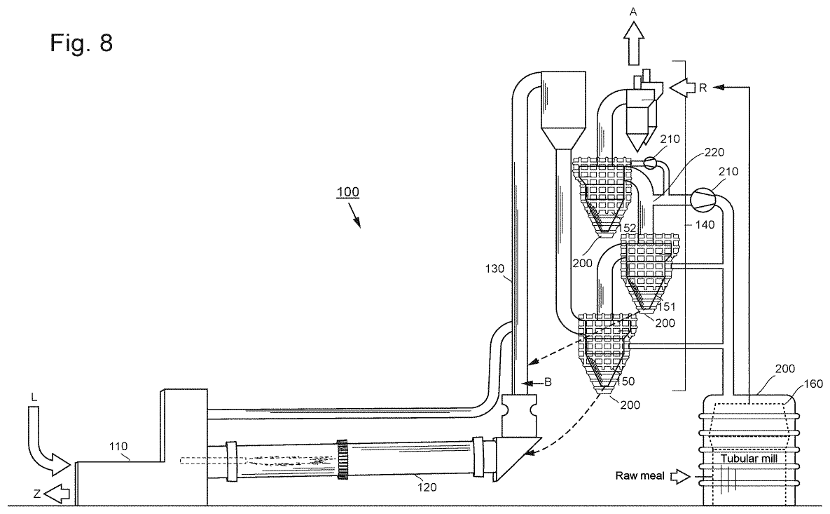

Lastly, FIG. 8 shows a diagram of a plant 100 for producing cement clinker, having partially enclosed plant assemblies AG. The plant assemblies can be selected from the group consisting of the clinker cooler 110, the rotary kiln 120, the calcinator 140, the individual cyclone heat exchangers 150, 151 and 152 of a heat exchanger line, and a ball mill or a vertical mill, as depicted here in the form of a comminuting plant 160. High-pressure roller presses also come into consideration for an enclosure by way of a shell 200.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 Plant
110 Clinker cooler
120 Rotary kiln
130 Calcinator
140 Heat exchanger line
150 Cyclone heat exchanger
151 Cyclone heat exchanger
152 Cyclone heat exchanger
160 Comminuting apparatus
161 Ball mill
200 Shell
210 Compressor
220 Central location
250 Outlet valve
260 Controller
A Waste air
AG Plant assembly
B Fuel
L Air
M Grinding material
P Process gas
R Raw meal
Z Cement clinker

1.-10. (canceled)

11. A method for operating a plant for producing cement clinker, wherein the plant, in a gas flow direction, has at least one clinker cooler, at least one rotary kiln, at least one calcinator, at least one heat exchanger line comprising a plurality of cyclone heat exchangers, and at least one apparatus for comminuting raw meal, cement clinker, or both, all forming a plant assembly, the method comprising:
enclosing the plant assembly with an enclosure to provide the plant assembly with a shell with respect to an atmosphere around the plant assembly, and
providing a process gas into the enclosure via a compressor.

12. The method according to claim 11, wherein the process gas is removed directly upstream of the enclosed plant assembly in the gas flow direction.

13. The method according to claim 11, wherein the process gas is removed from the assembly plant at a central location.

14. The method according to claim 11, further comprising:
regulating the compressor with an excess pressure relative to a pressure of removed process gas, wherein a compressor power is reduced as the pressure rises, and the compressor power is increased as the pressure is reduced.

15. The method according to claim 1, further comprising:
regulating an outlet valve, which is connected to an inner space of the enclosure in the flow direction, with an excess pressure relative to a pressure of removed process gas,
wherein an opening width of the outlet valve is increased as the pressure rises, and the opening width of the outlet valve is decreased as the pressure decreases.

16. A plant for producing cement clinker, the plant comprising, in a gas flow direction:
at least one clinker cooler,
at least one rotary kiln,
at least one calcinator,
at least one heat exchanger line, comprising a plurality of cyclone heat exchangers, and
at least one apparatus for comminuting raw meal, cement clinker, or both,
all forming a plant assembly,
wherein the plant assembly comprises an enclosure formed by a shell, as a result of which the plant assembly has a shell with respect to an atmosphere around the plant assembly,
wherein the enclosure formed by the shell is connected in terms of flow to a compressor configured to provide process gas to the enclosure.

17. The plant according to claim 16, wherein, on an inlet side, the compressor is connected to the plant, and, in the gas flow direction of the plant, is arranged directly upstream of the plant assembly.

18. The plant according to claim 16, wherein, on an inlet side, the compressor is connected to the plant, and, in the gas flow direction of the plant, is arranged at a central location.

19. The plant according to claim 16, wherein the compressor is connected to a controller configured to control the compressor via an excess pressure in the enclosure with respect to a pressure of a removed process gas,
wherein the controller reduces a compressor power as the pressure rises, and increases the compressor power as the pressure decreases.

20. The plant according to claim 16, wherein the enclosure is connected to an outlet valve,
wherein the outlet valve is connected in terms of control to a controller, and
wherein the controller is configured to increase an opening width of the outlet valve as a pressure rises, and to decrease the opening width of the outlet valve as the pressure decreases.
